(19) United States
(12) Patent Application Publication
(10) Pub. No.: US 2005/0004947 A1
(43) Pub. Date: Jan. 6, 2005

(54) Integrated tool set for generating custom reports

(76) Inventors: James L. Emlet, Falls Church, VA (US); Devin T. Moran, Washington, DC (US)

Correspondence Address: Raymond Jones, Esq.;IP Law Global, PC, Suite 550 - PMB5537, 11921 Freedom Drive, Reston, VA, 20190, US

(21) Appl. No.: 10/867,813

(22) Filed: Jun. 16, 2004

Related U.S. Application Data
(60) Provisional application No. 60/483,174, filed on Jun. 30, 2003.

(51) Int. Cl. G06F 17/00

(52) U.S. Cl. 707/104.1

(57) ABSTRACT

A process and graphical user interface for generating and modifying customized reports based on criteria specified by a user. After uploading data supplied by the user to a customer unique database structure having predefined data elements, report data elements are selected from the predefined data elements. Timeframes and variables associated with the report data elements are then selected, and the table layout is formatted. A report is generated, and afterwards, the user can easily change the report by changing any one of the report data elements, timeframes or variables, without reprogramming a database program or application processing software associated with generating the report.

### RELATED APPLICATIONS

This application claims priority from U.S. Provisional Patent Application No. 60/483,174 filed Jun. 30, 2003, which is hereby incorporated by reference in its entirety.

### BACKGROUND OF THE INVENTION

The invention is broadly directed to document management systems, and more specifically to a comprehensive, integrated tool set for generating customized reports quickly, efficiently, and without the need for extensive training in the underlying software program that manipulates the data.

Many organizations store data in single or multiple sources, making it difficult for front-line managers, partners, and senior management to access and/or present the data in a fast and user-friendly format.

Additionally, organizations need to quickly manipulate data to understand performance and/or trends from multiple perspectives, which is becoming increasingly complex. Another pressing need is the requirement to develop reports and data sets in a manner that is cost effective and efficient.

While conventional reporting systems in the marketplace allow users to build reports, they require knowledge of the underlying software program or professional help to build and/or modify the reports. Streamlining this cumbersome process would save organizations significant monetary and personnel resources, while also providing greater flexibility when developing business strategies. Additionally, many organizations require staff, partners, and senior managers to remain focused on key long-term strategic measures in a decentralized manner and retain control as to which audience or individual has access to which data set or report.

Accordingly, what is needed is an improved reporting system and delivery method to provide greater flexibility for organizations.

### SUMMARY OF THE INVENTION

The present invention provides a system and process for allowing organizational information to be collected, processed, organized and delivered to users in a format specified by the users. Each user can have organization-wide, group-wide, or individual specific reports that are organized and formatted to their individual needs and permission/access level. The reports can be branded for organizational needs. Users can change reports, timelines, and/or formats with just a single step. The end-user requires no knowledge of any programming language to generate custom reports using the inventive one-click reporting (OCR) functionality described herein.

The present invention further provides a system and process for updating reports automatically, without software installation, and without programmer knowledge on the part of the user. The server updates reports at intervals defined by the organization or administrator, with information provided directly from the organization or from a single or multiple third party or parties.

In one embodiment, the invention provides a graphical user interface and process for generating and modifying customized reports based on criteria specified by a user, comprising steps of uploading data supplied by the user to a database structure, the database structure having predefined data elements specified by the user; selecting report data elements from the predefined data elements; selecting timeframes for the report data elements; selecting variables associated with the report data elements; formatting a table layout including the selected variables; and generating a report comprising the formatted table layout and displaying the report to the user, whereby the user can change the report by modifying any one of the prior selecting or formatting steps, without reprogramming a database program or application processing software associated with generating the report.

### BRIEF DESCRIPTION OF THE DRAWINGS

The advantages of the present invention will become more apparent by describing in detail the preferred embodiments thereof with reference to the drawings. The drawings, many of which are software screen captures, and the content of the drawings, are hereby specifically incorporated by reference into the detailed description:

FIG. 1 shows the data flow from the time data is uploaded to the time the end user can access reports on the data.

FIG. 2 shows the overall application architecture.

FIG. 3 is an example of the Dashboard.

FIG. 4 is an example of the User Admin tab, including the User Listing and Group Listing modules.

FIG. 5 is the User Admin business logic flowchart.

FIG. 6A is a table describing the permissions for each user.

FIG. 6B is an example of the Update User window.

FIG. 7 is the Update User business logic flowchart.

FIG. 8 is an example of the Add Group window.

FIG. 9 is the Add Group logic flowchart.

FIG. 10 is a User Admin Deleted flowchart.

FIG. 11 is an example of an Add User window.

FIG. 12 is the Add User logic flowchart.

FIG. 13 is an example of the Group Listing window.

FIG. 14 is an example of the Update Group window.

FIG. 15 is the Group Admin Update flowchart.

FIG. 16 is the Group Admin Delete flowchart.

FIG. 17 is an example of the Dashboard Listing window.

FIG. 18 is the Dashboard Admin flowchart.

FIG. 19 is an example of a Dashboard Details window.

FIG. 20 is the Dashboard Admin View Flowchart.

FIG. 21 is an example of an Add Module window.

FIG. 22 is an example of an Add Dashboard flowchart.

FIG. 23 is an example of a User Listing window in the Add module as it appears when user permissions are being assigned.

FIG. 24 is an example of a User Listing window in the Add module as it appears when another user is being added.

FIG. 25 is an example of a Group Listing window in the Add module as it appears when group permissions are being assigned.

FIG. 26 is an example of a Group Listing window in the Add module as it appears when a new group is being added.

FIG. 27 is an example of a Delete Dashboard window.

FIG. 28 is the Delete Dashboard flowchart.

FIG. 29 is an example of a Create Another Dashboard window.

FIG. 30 is an example of a Module Listing window.

FIG. 31 is the Module Admin flowchart.

FIG. 32 is an example of a Module Listing window.

FIG. 33 is the Module Admin Edit flowchart.

FIG. 34 is an example of a User Listing window in the Update module as it appears when permissions are being assigned.

FIG. 35 is an example of a User Listing window in the Update module as it appears when a new user is being added.

FIG. 36 is an example of a Group Listing window in the Update module as it appears when group permissions are being assigned

FIG. 37 is an example of a Group Listing window in the Update module as it appears when a new group is being added.

FIG. 38 is the View Details flowchart.

FIG. 39 is an example of the Profile window.

FIG. 40 is the Profile flowchart.

FIG. 41 is an example of the Hidden Modules window.

FIG. 42 is the Hide Modules flowchart.

FIG. 43 is an example of a Group window.

FIG. 44 is an example of a Submit Data window.

FIG. 45 is an example of a Submit Data window with a status message.

FIG. 46 is an example of a Submit Data window.

FIG. 47 is an example of a Submit Data window with a status message.

FIG. 48 is an example of a Select File window.

FIG. 49 is an example of an error message.

FIG. 50 is an example of an error message.

FIG. 51 is an example of an upload status message.

FIG. 52 is the Report Builder Process flowchart.

FIG. 53 is the main Report Builder window.

FIG. 54 is an example of a Select the Timeframe window in the Report Builder.

FIG. 55 is an example of a Select the Variables and Timeframes window in the Report Builder.

FIG. 56 is an example of a Select The Data Elements window in the Report Builder.

FIG. 57 is an example of a Format The Table window in the Report Builder.

FIG. 58 is an example of a Preview The Table window in the Report Builder.

FIG. 59 is an example of a Generate A Report window in the Report Builder.

FIG. 60 is an example of a confirmation that a data file was posted to the website successfully.

FIG. 61 is an example of email correspondence summarizing data submitted that is sent to the person that posted the data file.

FIG. 62 is an example of the Data Updated module on the Home Page letting the user know what date the data has been received through.

### DETAILED DESCRIPTION OF THE INVENTION

The present invention will now be described more fully with reference to the accompanying drawings, in which preferred embodiments of the invention are shown. The invention may, however, be embodied in many different forms and should not be construed as being limited to the embodiments set forth herein. Rather, the embodiments are provided so that this disclosure will be thorough and complete, and will fully convey the concept of the invention to those skilled in the art.

Also, while certain data fields for each software module/function are set forth in the document description, it would be understood by one of ordinary skill in the art that throughout the discussion, additional data fields can be included in the database and subsequent reports, data fields can be deleted, or data fields can be identified with different aliases. Rather than repeating this feature after each module discussion, this statement is meant to pertain globally to the document and modules described herein.

What follows is a brief overview of the system, including the user interface and system structure, followed by a more specific and detailed description of the user interface module (referred to as the “dashboard” or “one-click reporting dashboard”) as well as the user and module administrative features.

The present invention provides a system and process that allows organizational information to be collected, processed, organized and delivered to users in a format specified by users, not the software vendor or other third party software hosting facility. Each user can have organization-wide, group-wide, or individual specific reports that are organized and formatted to their individual needs and access level. The reports can also be branded by organizational need. Users can change reports, timelines, and/or formats with one step.

The present invention could be operated over dedicated computer networks, using a conventional hardware configuration comprising a server and associated computers within a single organization. In a preferred embodiment, the present invention could also be operated over distributed computer networks, such as the Internet or wide-area network (WAN), with a conventional hardware configuration comprising a central server computing facility and a distributed network of client computers spread across multiple, separate organizations. Each of the multiple organizations would have secure access to its own set of data on the central computer. The following description will focus on the web-based version of the software for simplicity and ease of discussion, with the features being the same for a dedicated computer network.

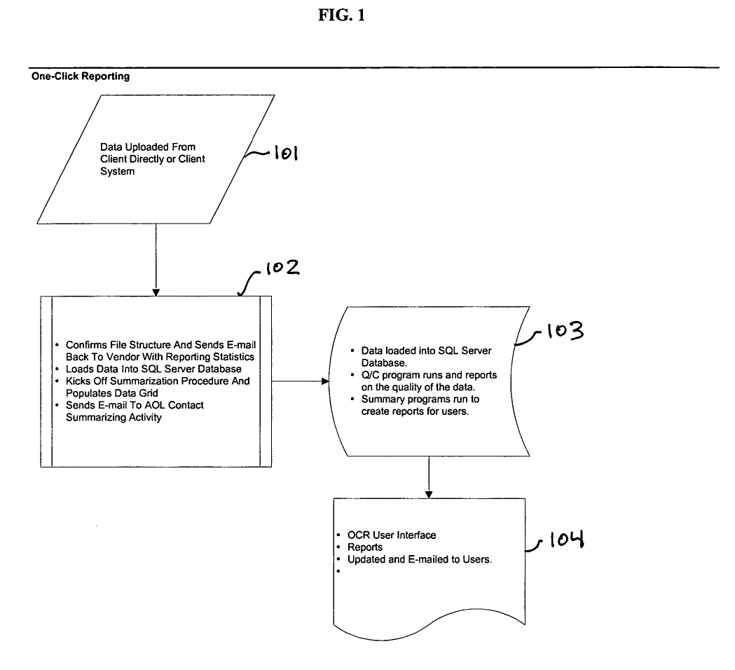

First, each software installation must be initially tailored to the end user/customer, so the customer does not have to reformat its existing database. The first step, therefore, is to understand the database structure of the customer and then upload the data to the central server operated by the software vendor using a database structure comprising those data elements predefined or specified by the user. See FIG. 1, step 101. The central server configuration may be dedicated, shared, or the software vendor may use multiple servers. Any commercially available server running commercially available database software may be used.

As shown in FIG. 1, step 102, once the customer's native file structure is confirmed, an email is sent back to the customer with high-level reports on the quality of the data. The data is then loaded into a conventional server database. This commences a series of summarization and quality control procedures that populate the customized data model for the customer. This enables the present invention to be tailored to individual customer needs. Once the summarization process is complete, another e-mail is sent to the customer announcing the availability of the updated reports (step 103). New data elements can be added to the database, data elements can be deleted from the database, or existing data elements can be modified, by employing the uploading procedure in step 101.

After this initial tailoring and importing of the client data, the customer can access the data (step 104) through a “one-click reporting dashboard” or graphical user interface, the features of which are described further below. The reporting tool set of the present invention enables customers to create customized reports and charts and use them over and over again, and to easily change them when necessary. The applications that currently fit into this tool set are the dashboard, a detail report and a custom report builder. These applications are preferably bundled together and productized as a reporting toolset for customers, although they need not be. In addition, other functionality may be added as part of the tool set. This would require additional modules to be created and integrated into the dashboard.

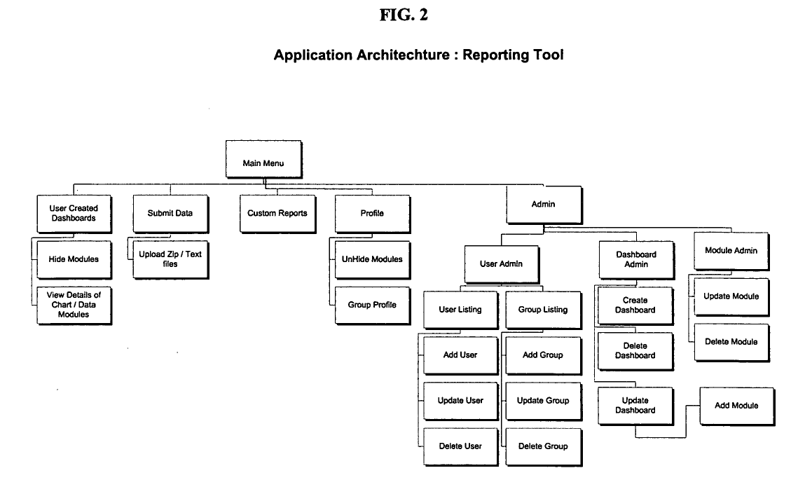

The dashboard feature will now be described in greater detail, with screen shots of the web interface and business logic flow charts. The overall application architecture is summarily set forth in FIG. 2.

User Created Dashboards

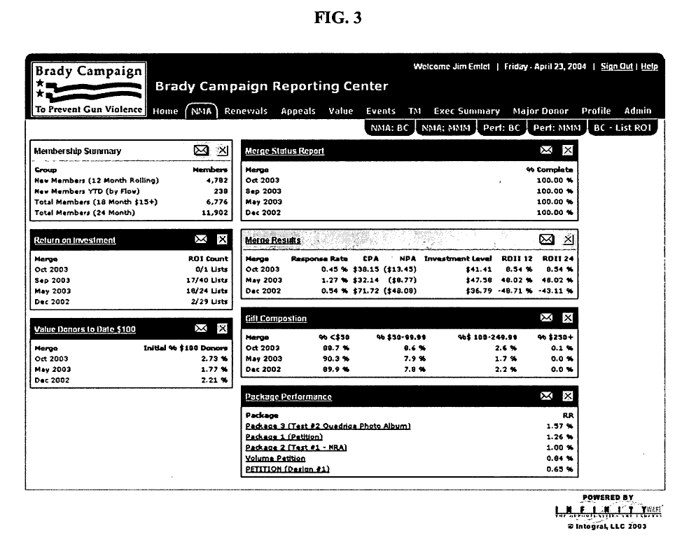

A Dashboard is a collection of report and chart modules customized for specific users. Each cell in the Dashboard is a module. The Dashboard application consists of several tabs, including User Created Dashboards, Submit Data, Profile and Admin. See FIG. 3.

Admin Tab

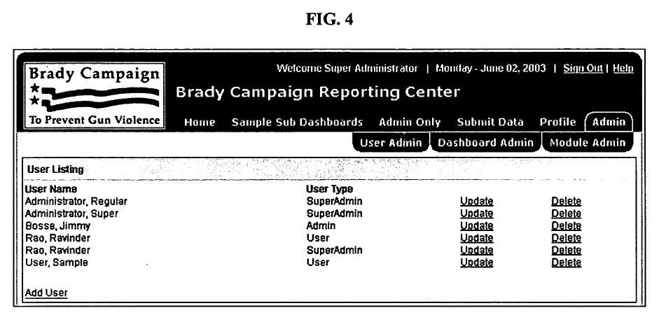

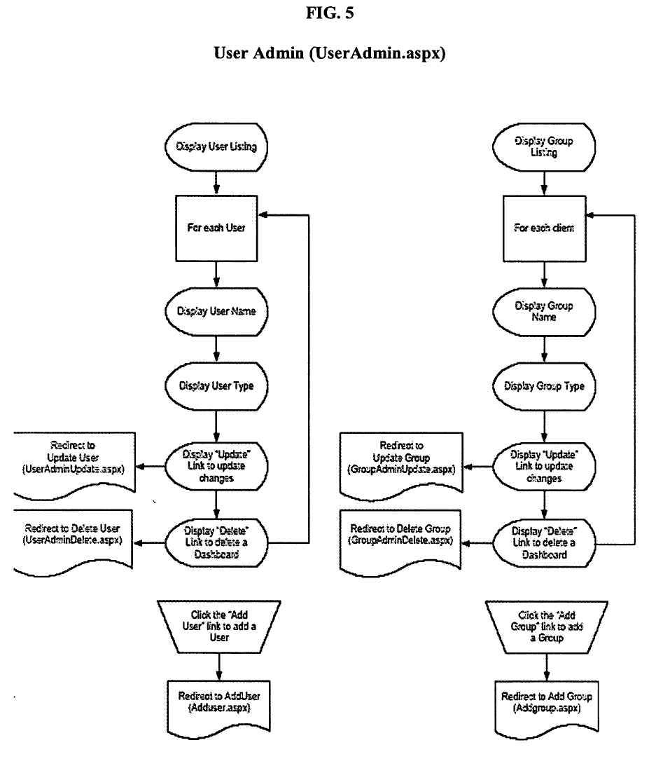

The Admin tab consists of User Admin, Dashboard Admin and Module Admin. See FIG. 4 and FIG. 5.

User Admin

User Admin allows creation of new users or new groups, and assigns users to one or more groups. The User Admin tab consists of User Listing and Group Listing modules.

User Listing

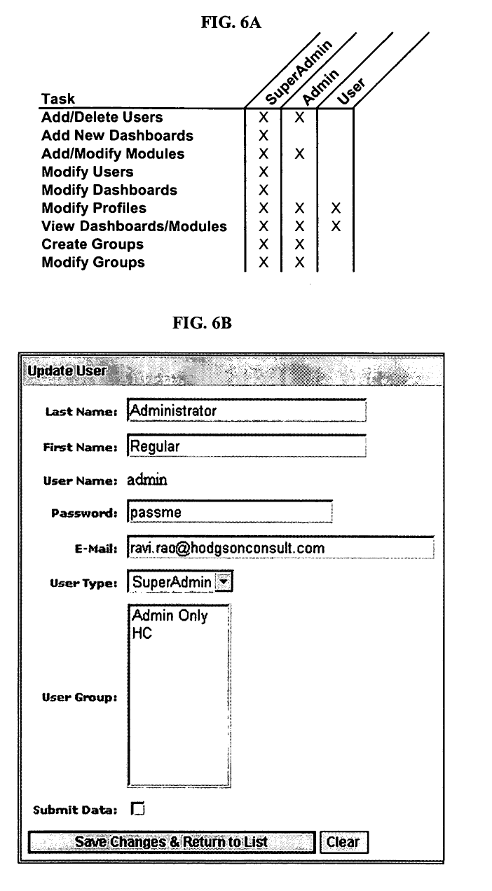

User Listing displays the following for every user:
1. User Name
2. User Type (permission level—see FIG. 6A)
3. Update Link
4. Delete Link

Update User

Clicking Update Link in FIG. 4 will open up the ‘Update User’ form and the user must enter the following information:
1. LastName
2. FirstName
3. Display UserName
4. Password
5. Email
6. User Type
7. User Group
8. Submit Data

See FIG. 6A, FIG. 6B and FIG. 7.

User Type selections include SuperAdmin, Admin, and User. One of ordinary skill in the art would understand that additional permission levels might be provided as well. FIG. 6A illustrates exemplary permissions associated with each level.

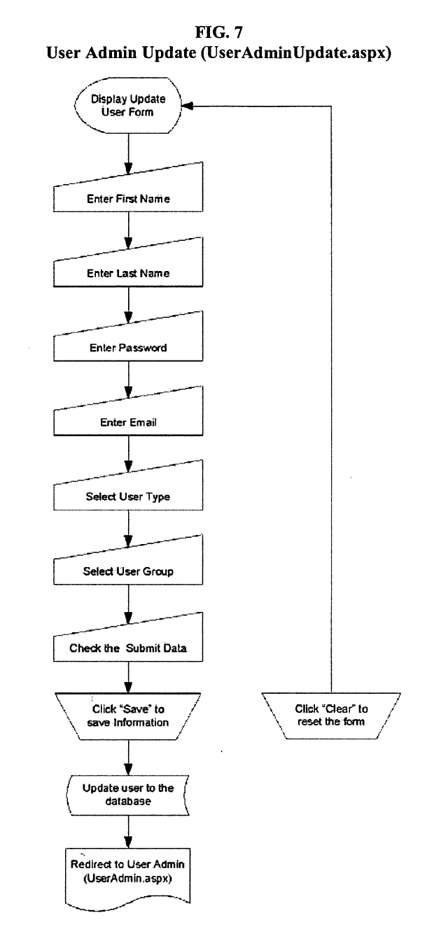

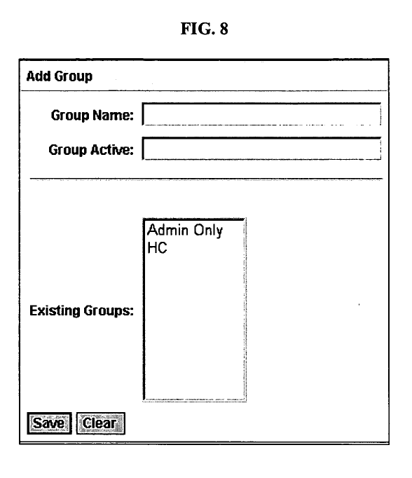

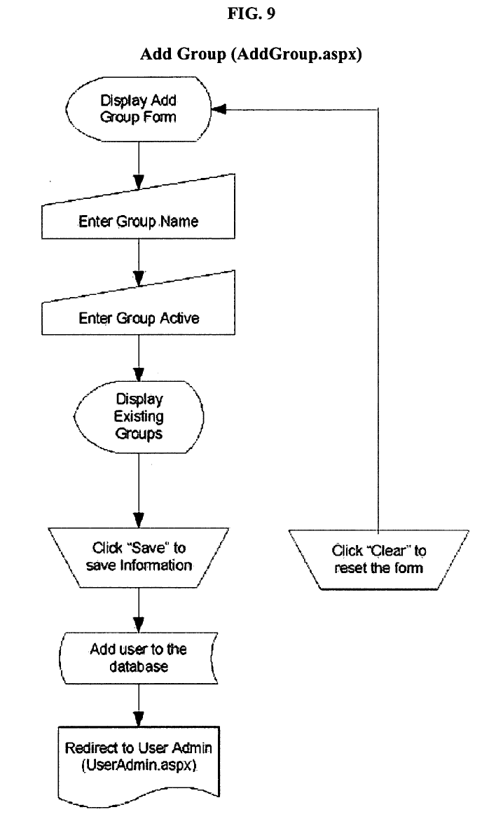

User Group selections include those Groups that were added (Add Group) in accordance with the description of FIG. 8 and FIG. 9.

By “checking” the Submit Data box in FIG. 6B, an additional dashboard is presented, allowing you to submit data into the database. If Submit Data is left unchecked, then the user will not see the Submit Data dashboard, which effectively does not allow the user to submit data.

Clicking the ‘Save Changes’ button updates the database and redirects the user to the User Admin screen.

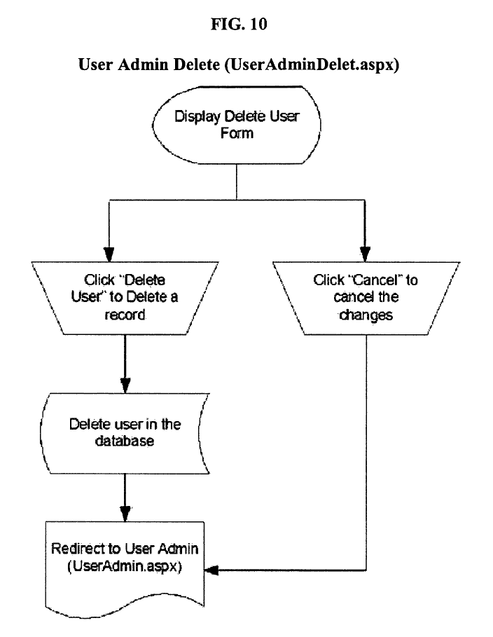

Delete User Clicking the Delete Link in FIG. 4 will open up the ‘Delete User’ screen. This screen allows the user to confirm that they want to delete that particular user by clicking the ‘Delete User’ button. This will delete that user and redirect the user to the User Admin screen. Alternatively the user can click the ‘Cancel’ button to cancel the delete. See FIG. 10.

Add User

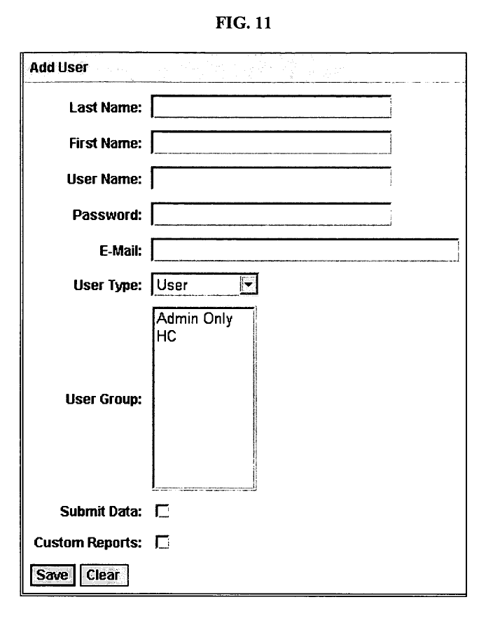

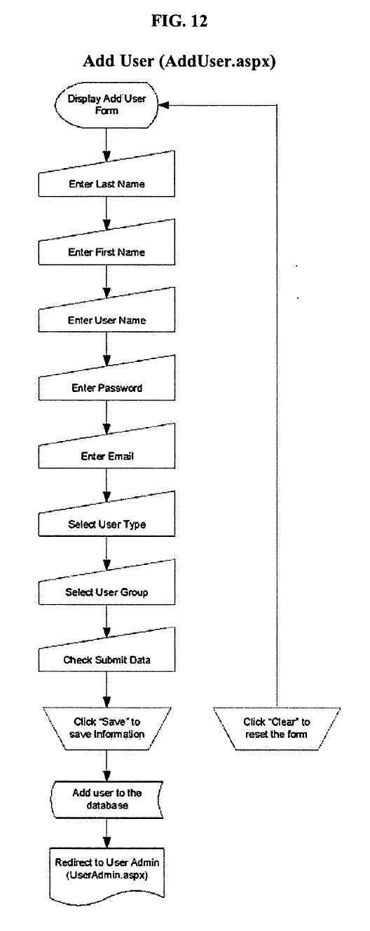

Clicking the Add User link in FIG. 4 will open up the ‘Add User’ screen, which requests the following data (see FIG. 11 and FIG. 12):
1. LastName
2. FirstName
3. UserName
4. Password
5. Email
6. User Type
7. User Group
8. Submit Data
9. Custom Reports

By checking the Custom Reports box in FIG. 11, the user will be able to create an individualized report using the Query Tool Application (also know as Report Builder, which is described later). If the Custom Report box is left unchecked, then the user will not see the Custom Report dashboard and will not be able to create individualized reports.

Clicking the ‘Save’ button in FIG. 11 updates the database and redirects the user to User Admin screen of FIG. 4. Clicking the ‘Clear’ button resets the form.

Users can also request a forgotten password, which is sent to them immediately with the password request functionality.

Group Listing

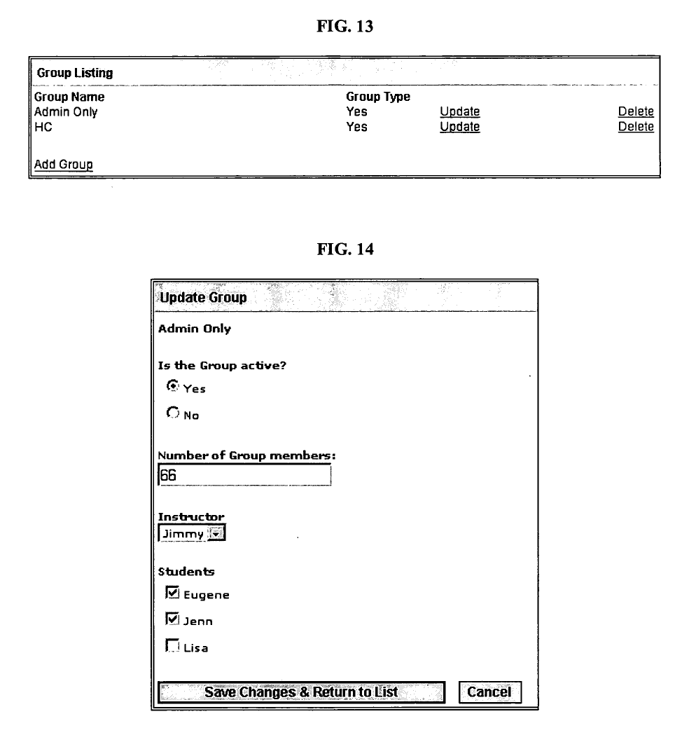

Group Listing (see FIG. 13) displays the following for every group:
1. Group Name
2. Group Type
3. Update Link
4. Remove Link

Update Group

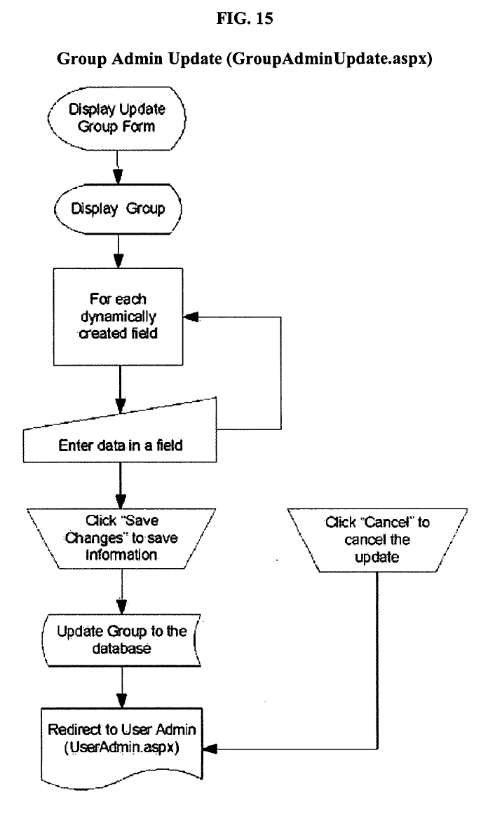

Clicking the Update Link in FIG. 13 will open up the ‘Update Group’ form and the group must enter the following information (see FIG. 14 and FIG. 15):
1. Display Group Name
2. Select ‘Yes’ or ‘No’ to specify if the group is active
3. Enter other data in dynamically created fields (Number of Group Members, Instructor, Students, etc.) if applicable.

Clicking the ‘Save Changes & Return to List’ button updates the database and redirects the user to User Admin screen of FIG. 4. Alternatively the user can click the ‘Cancel’ button to cancel the changes.

Delete Group

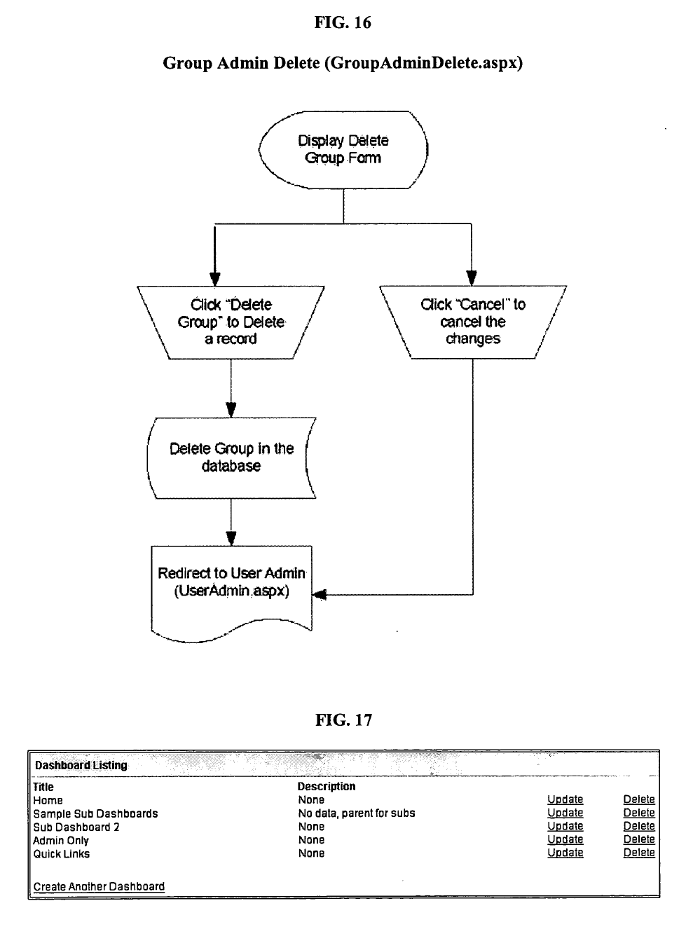

Clicking the Delete Link of FIG. 13 will open up the ‘Delete Group’ screen. This screen allows the user to confirm that they want to delete that particular group by clicking the ‘Delete Group’ button. This will delete that group and redirects to the User Admin screen (see FIG. 16). Alternatively the user can click the ‘Cancel’ button to cancel the delete.

Add Group

Clicking the Add Group link of FIG. 13 will open up the ‘Add Group’ screen and the user must enter the following information.
1. Group Name
2. Group Active
3. Select Existing Groups

See FIG. 8 and FIG. 9.

Clicking the ‘Save’ button in FIG. 8 updates the database and redirects the user to User Admin screen of FIG. 4. Clicking the ‘Clear’ button resets the form.

OCR Dashboard Admin

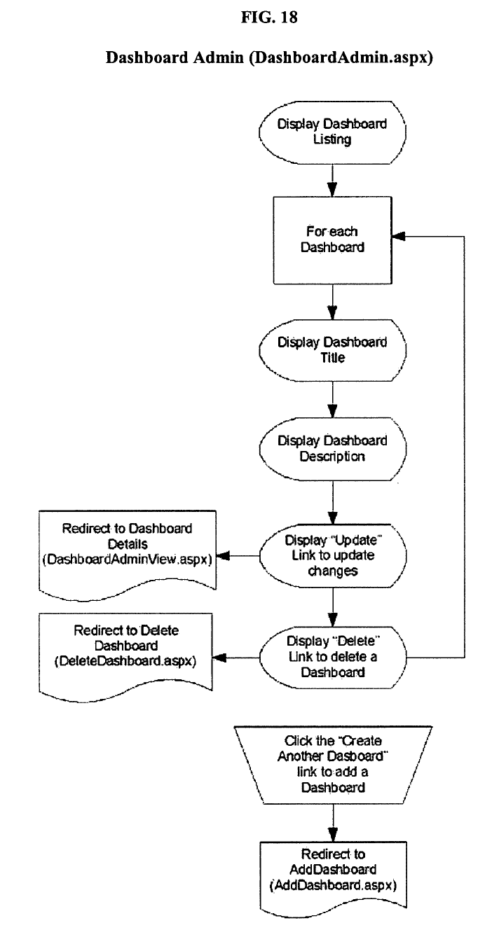

One-Click Reporting Dashboard Admin allows the creation of new Dashboards, updates of existing Dashboards and allows users with the requisite permission to delete Dashboards. An authorized user can also add new groups and assign users to one or more groups. Also, the Dashboard Admin allows Users to define which tasks could be performed by which security levels. Dashboard Admin tab consists of User Listing and Group Listing modules (see FIG. 17 and FIG. 18).

Dashboard Listing displays the following for every user:
1. Dashboard Name
2. Dashboard Description
3. ‘Update’ Link
4. ‘Delete’ Link

Update Dashboard

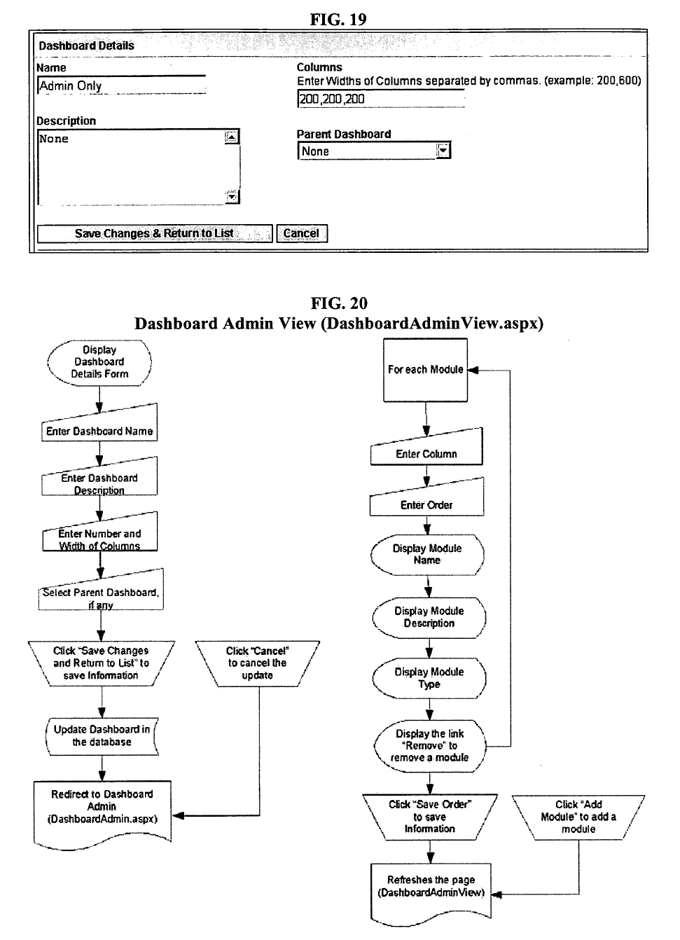

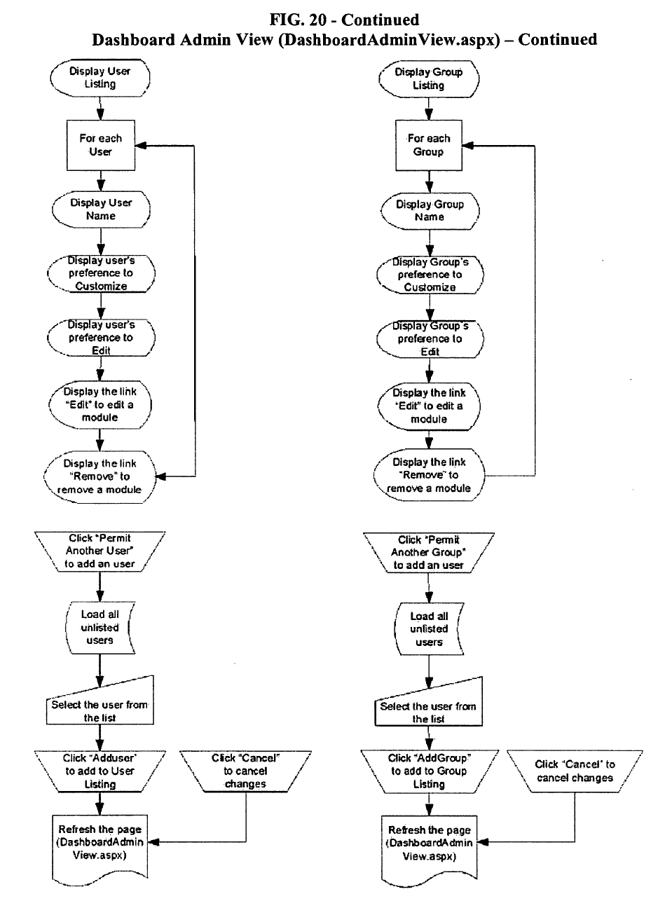

Clicking Update Link of FIG. 17 will open up the ‘Dashboard Details’ form and the user must enter the following information (see FIG. 19 and FIG. 20):
1. Dashboard Name
2. Dashboard Description
3. Columns—Enter Widths of Columns separated by commas. (example: 200,600)
4. Select Parent Dashboard—If this is selected the child dashboard appears under the parent dashboard. If none is selected the dashboard appears on the main page.

Clicking the ‘Save Changes & Return to List’ button of FIG. 19 updates the database and redirects the user to Dashboard Admin screen of FIG. 17. Alternatively the user can click the ‘Cancel’ button to cancel the changes.

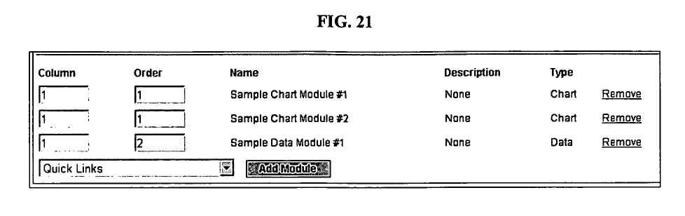

As shown in FIG. 21, the user can specify the number of columns. They can also choose the order in which the modules should appear within the columns. For example, if there are two modules, the user can choose to place module #1 in column 1 and place module #2 in column 2. Or the user can place the modules one below the other. In short, they can choose the columns and order. Clicking the ‘Remove’ Link of FIG. 21 will remove a module from that dashboard.

Add Module

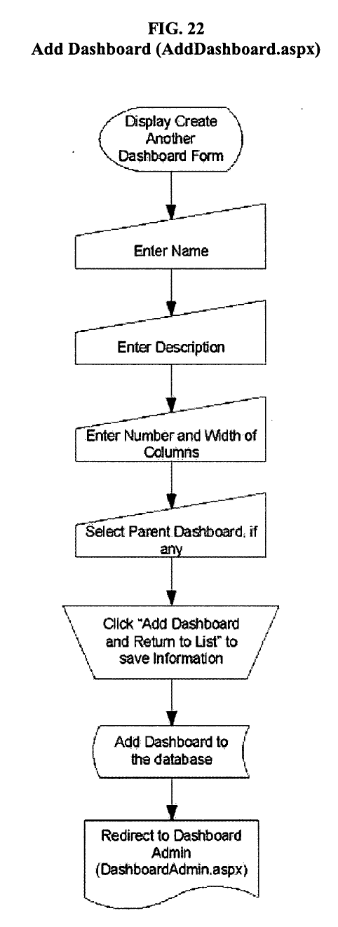

The user can also add modules using the ‘Add Module’ button of FIG. 21 (see also FIG. 22.) When the ‘Add Module’ button is clicked, a drop down list of all available modules (that are not already on that Dashboard) will appear. The user can select one of them and click the ‘Add Module’ button again. This will add that module to the chosen dashboard. The user then can modify the layout of the dashboard as described above.

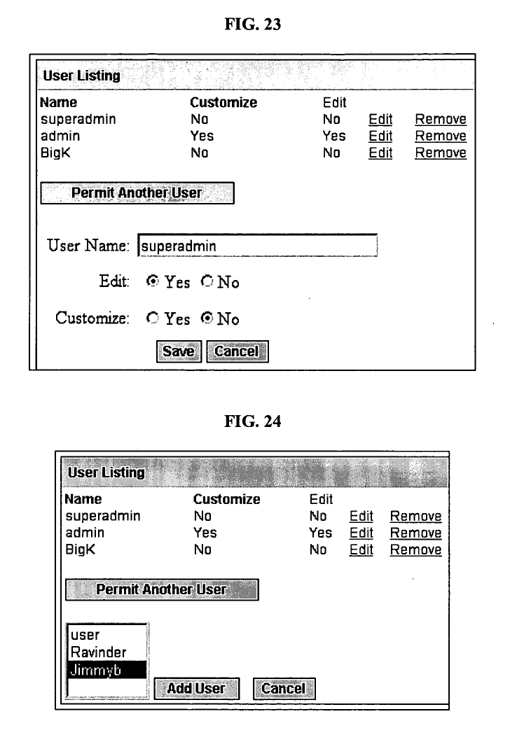

User Listing displays the following for every user (see FIG. 23):
1. Name
2. Customize (Yes/No)
3. Edit (Yes/No)
4. Edit Link
5. Remove Link

Clicking on the Edit Link of FIG. 23, opens up an edit screen (within the User Listing screen) where the user can edit name, and specify edit and customize preferences (using radio buttons). They can then click on ‘Save’ button to save the changes and return to the same screen or click on ‘Cancel’ button to cancel the changes. Clicking on the Remove Link removes the user from the listing.

The user can also add another user by clicking on the ‘Permit Another User’ button of FIG. 23. A list of users—who are not already included—appears in a list box (see FIG. 24). User can select and click on ‘Add User’ button to add it to the User Listing and return to the same screen. Alternatively the user can click the ‘Cancel’ button to cancel the changes.

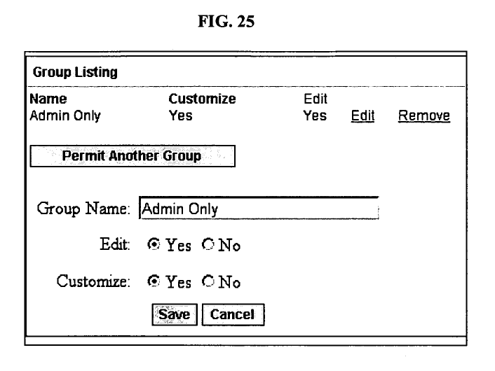

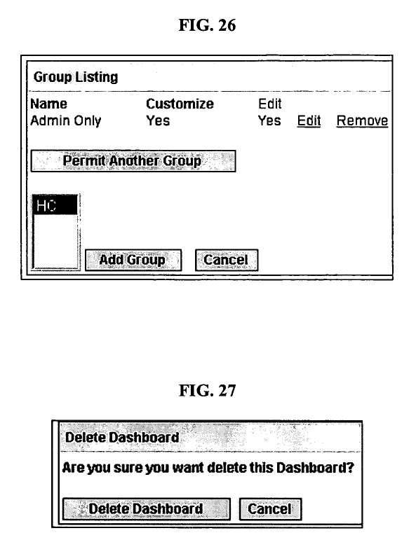

Group Listing displays the following for every Group (see FIG. 25 and FIG. 26):
1. Name
2. Customize (Yes/No)
3. Edit (Yes/No)
4. Edit Link
5. Remove Link

Clicking on the Edit Link of FIG. 25, opens up an edit screen (within the Group Listing screen) where the user can edit name, and specify edit and customize preferences (using radio buttons). They can then click on ‘Save’ button to save the changes and return to the same screen or click on ‘Cancel’ to cancel the changes. Clicking on the Remove Link removes the Group from the listing.

The user can also add another group by clicking on the ‘Permit Another Group’ button. A list of Groups—that are not already listed—appears in a list box (see FIG. 26). User can select and click on ‘Add Group’ button to add it to the Group Listing and return to the same screen. Alternatively, the user can click the ‘Cancel’ button to cancel the changes.

Delete Dashboard

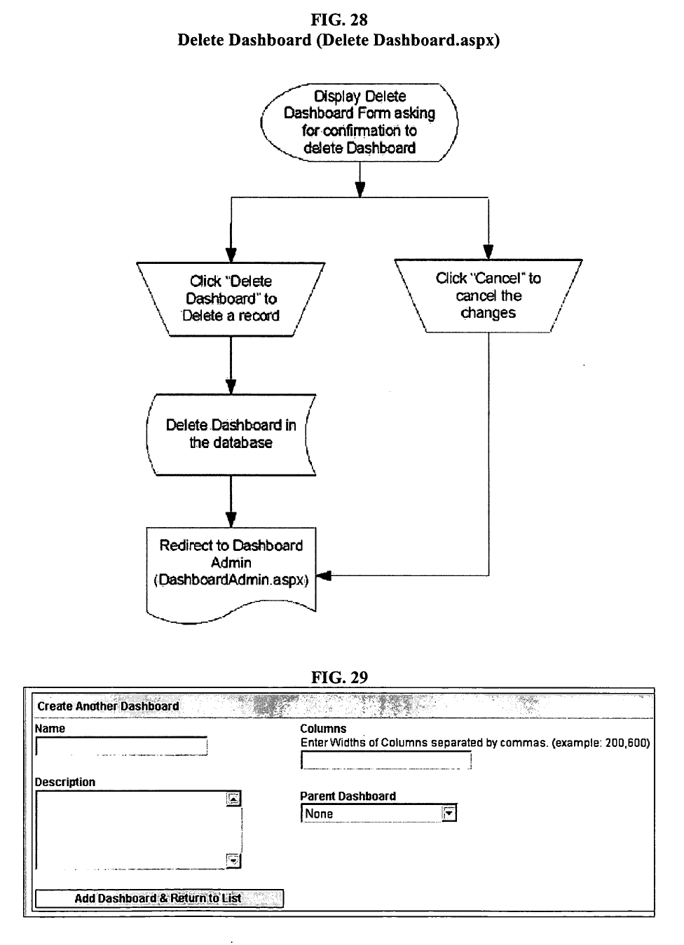

Clicking the Delete Link of FIG. 17 will open up the ‘Delete Dashboard’ screen (see FIG. 27 and FIG. 28). This screen allows the user to confirm that they want to delete that particular Dashboard by clicking ‘Delete Dashboard’ button. This will delete that Dashboard and redirect the user to the Dashboard Admin screen of FIG. 17. Alternatively, the user can click the ‘Cancel’ button to cancel the delete.

Create Dashboard

Clicking the Create Another Dashboard link of FIG. 17 will open up the ‘Create Another Dashboard’ form and the user must enter the following information (see FIG. 29):
1. Dashboard Name
2. Dashboard Description
3. Columns—Enter Widths of Columns separated by commas. (example: 200,600)
4. Select Parent Dashboard—If selected the child dashboard appears under the parent dashboard. If none is selected, the dashboard appears on the main page.

Clicking the ‘Add Dashboard & Return to List’ button updates the database and redirects the user to Dashboard Admin screen of FIG. 17. Alternatively, the user can click the ‘Cancel’ button to cancel the changes.

Module Admin

Module Admin allows the user to administer the collection of report and chart modules. This allows the user to update and delete existing Modules. An authorized user can also add new users and groups and assign users to one or more groups.

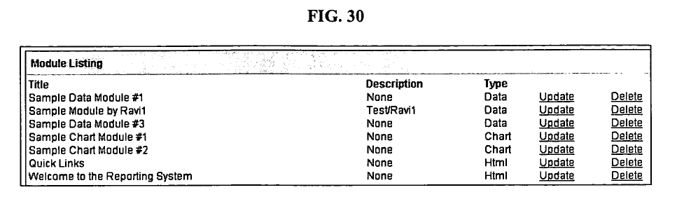

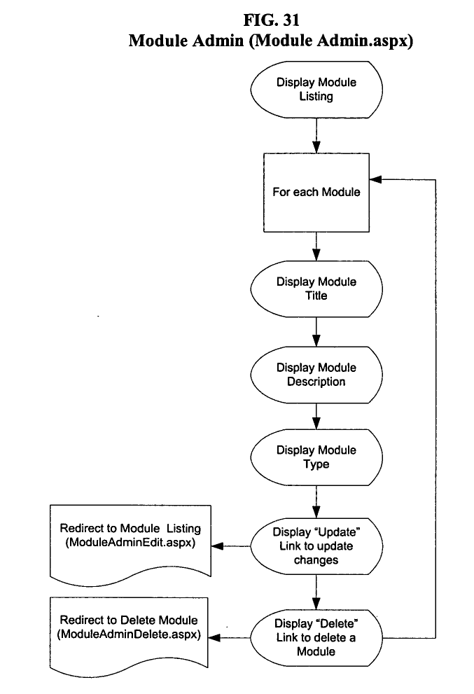

Modules can be created using a “Create Module” link in the Module Admin tab and the Super Administrators will be able to use it to create modules (see FIG. 30 and FIG. 31).

Module Listing displays the following for every module:
1. Title
2. Description
3. Type (Data/Chart/HTML)
4. Update Link
5. Remove Link

Update Module

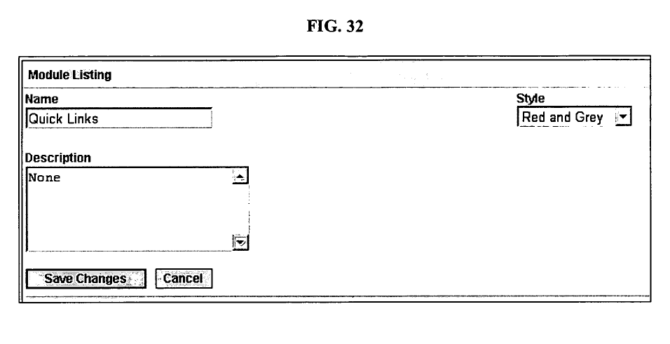

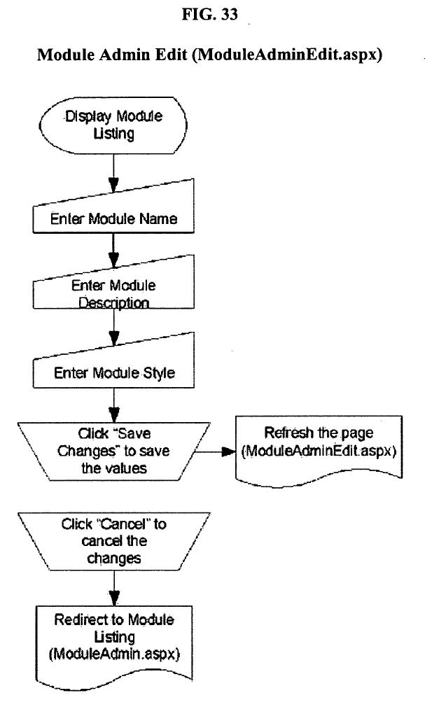

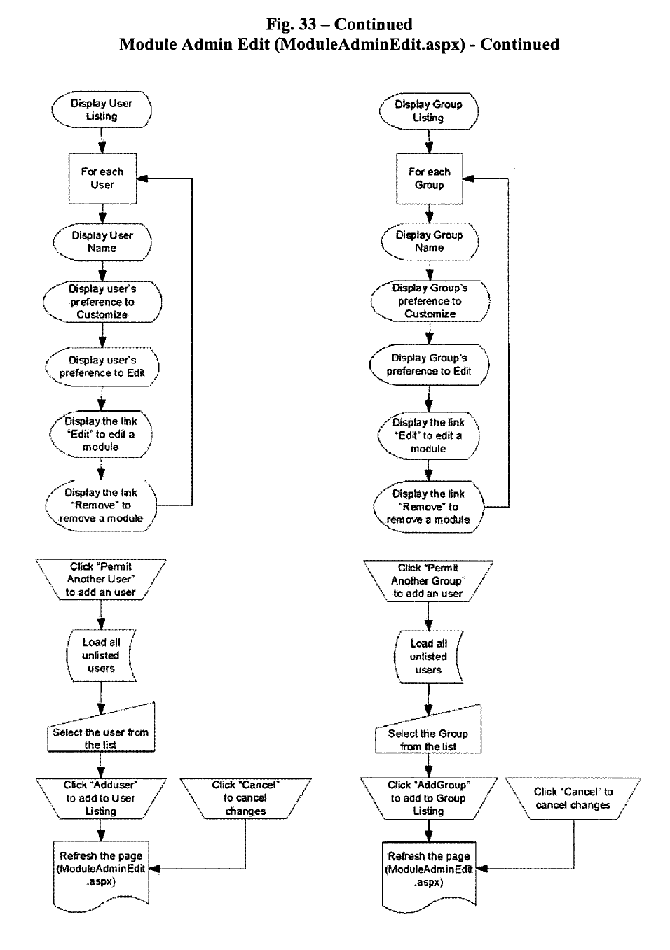

Clicking the Update Link of FIG. 30 will open up ‘Module Listing’ form. The Module Admin tab consists of User Listing and Group Listing modules (see FIG. 32 and FIG. 33). The user must enter the following information:
1. Module Name
2. Module Description
3. Select Style

Clicking the ‘Save Changes’ button updates the database and returns the user to the same screen. Alternatively the user can click the ‘Cancel’ button to cancel the changes.

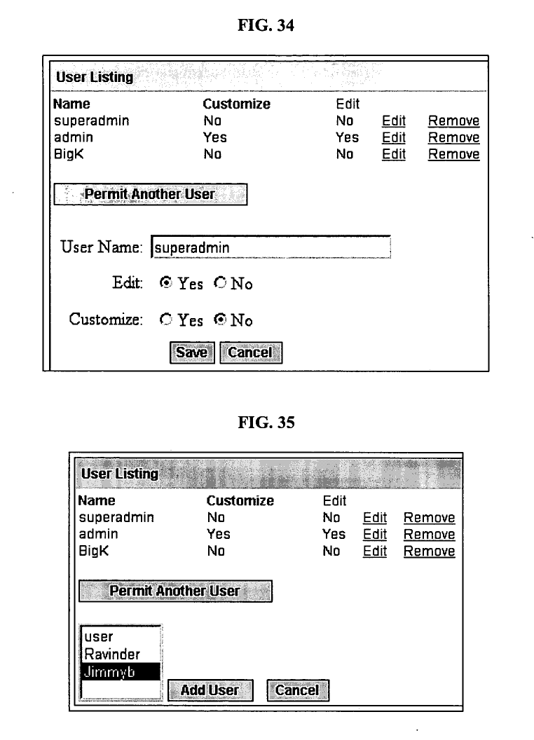

User Listing displays the following for every user (see FIG. 34):
1. Name
2. Customize (Yes/No)
3. Edit (Yes/No)
4. Edit Link
5. Remove Link

Clicking on the Edit Link, opens up an edit screen (within the User Listing screen) where the user can edit name, and specify their preferences by selecting customize and edit radio buttons. They can then click on the ‘Save’ button to save the changes and return to the same screen or click on ‘Cancel’ to cancel the changes. Clicking on the Remove Link removes the user from the listing.

The user can also add another user by clicking on the ‘Permit Another User’ button. A list of users who are not already listed appears in a list box (see FIG. 35). The User can select and click on ‘Add User’ button to add it to the User Listing and return to the same screen. Alternatively the user can click the ‘Cancel’ button to cancel the changes.

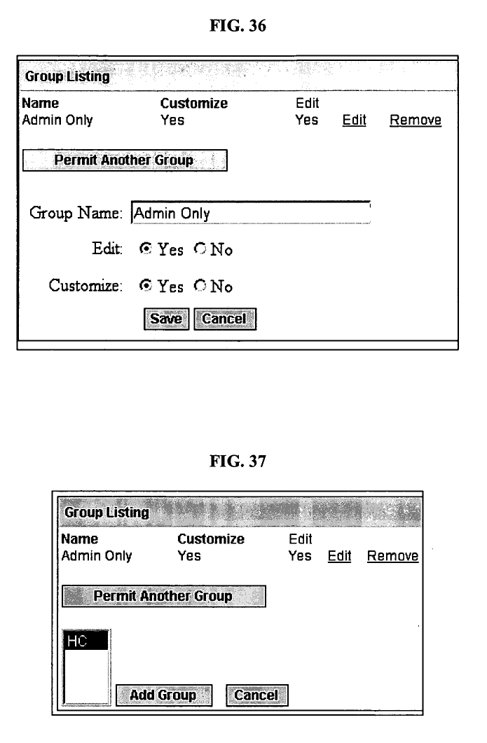

Group Listing displays the following for every Group (see FIG. 36):
1. Name
2. Customize (Yes/No)
3. Edit (Yes/No)
4. Edit Link
5. Remove Link

Clicking on the Edit Link, opens up an edit screen (within the User Listing screen) where the user can edit name, and specify their preferences by selecting customize and edit radio buttons. They can then click on the ‘Save’ button to save the changes and return to the same screen or click on ‘Cancel’ to cancel the changes. Clicking on the Remove Link removes the user from the listing.

The user can also add another group by clicking on the ‘Permit Another Group’ button. A list of groups—that are not already listed—appears in a list box (see FIG. 37). The User can select and click on ‘Add Group’ button to add it to the Group Listing and return to the same screen. Alternatively, the user can click the ‘Cancel’ button to cancel the changes.

Delete Module

Clicking the Delete Link of FIG. 30 will open up the ‘Delete Module’ screen. This screen allows the user to confirm that they want to delete that particular Module by clicking the ‘Delete Module’ button. This will delete that Module and redirect the user to the Module Admin screen. Alternatively, the user can click the ‘Cancel’ button to cancel the delete.

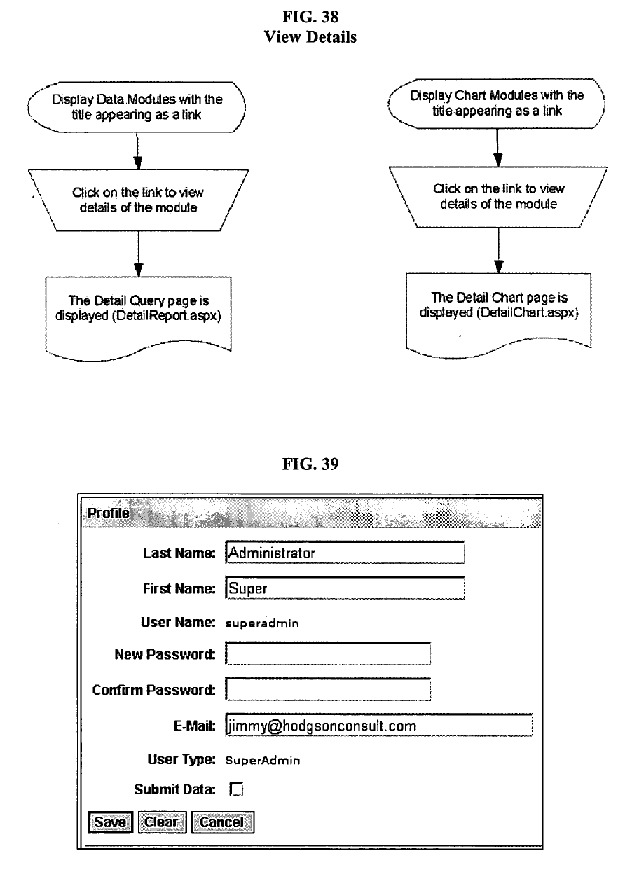

On the Dashboard, the user can display and view details of the Data Modules and the Chart Modules as described in FIG. 38.

Profile

The Profile tab allows users to edit their profile, to select a module and UnHide it, which then appears in the main page. It also allows the user to select a group, specify if the selected group is active, enter the number of members in that group and select the instructor and check students.

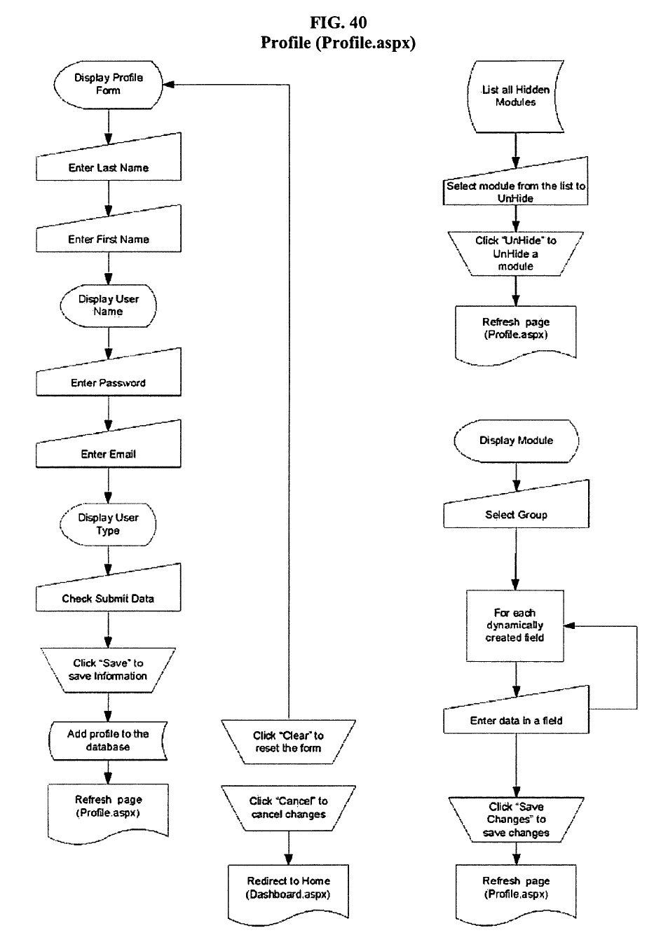

The Profile screen (see FIG. 39 and FIG. 40) has the following fields, where the user can enter the information and save it.
1. LastName
2. FirstName
3. UserName (Logged on user's name is displayed)
4. New Password
5. Confirm Password
6. Email
7. Submit Data

Clicking the ‘Save’ button updates the database and returns the user to the same screen. Clicking the ‘Clear’ button resets the form. Clicking the ‘Cancel’ button cancels the changes redirects the user to the Dashboard home page.

Unhide

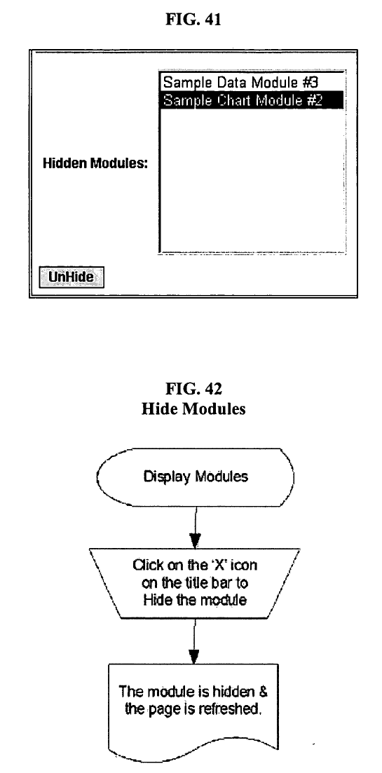

The user can select a module from the list that consists of all the hidden modules (see FIG. 40 and FIG. 41) and click the ‘UnHide’ button to unhide the module that will then reappear on the appropriate dashboard. The modules can be hidden by clicking on the ‘X’ icon that appears on the right-hand side corner of the title bar of the module. See FIG. 42.

Group Profile

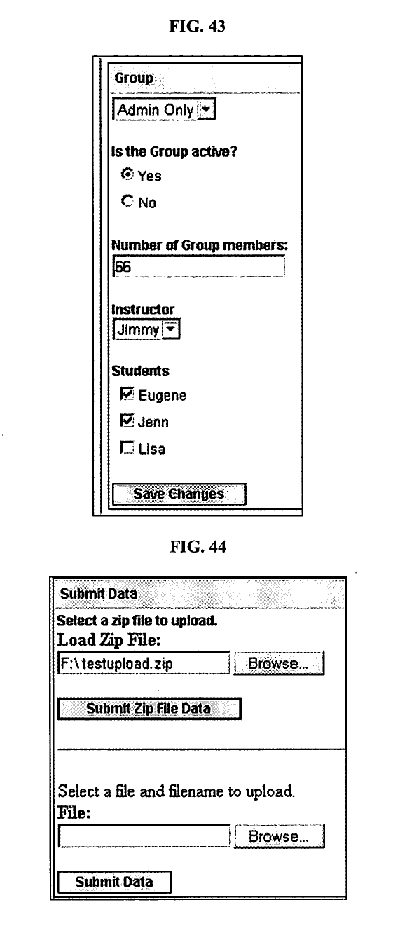

The Group form (see FIG. 43) allows the Admin User to select a group, specify if the selected group is active, and enter data in the other dynamically created fields.

Clicking the ‘Save Changes’ button updates the database and returns the user to same screen.

Submit Data

The Submit Data module of FIG. 44 allows the user to bring external data into the integrated reporting tool set for viewing in the Dashboards as well as for creating reports. Additionally, the user can get immediate reports back on the quality of their data. This allows the user to regulate how often the data in the database are updated—and monitor the quality of the data going into the database.

Uploading a Zip File

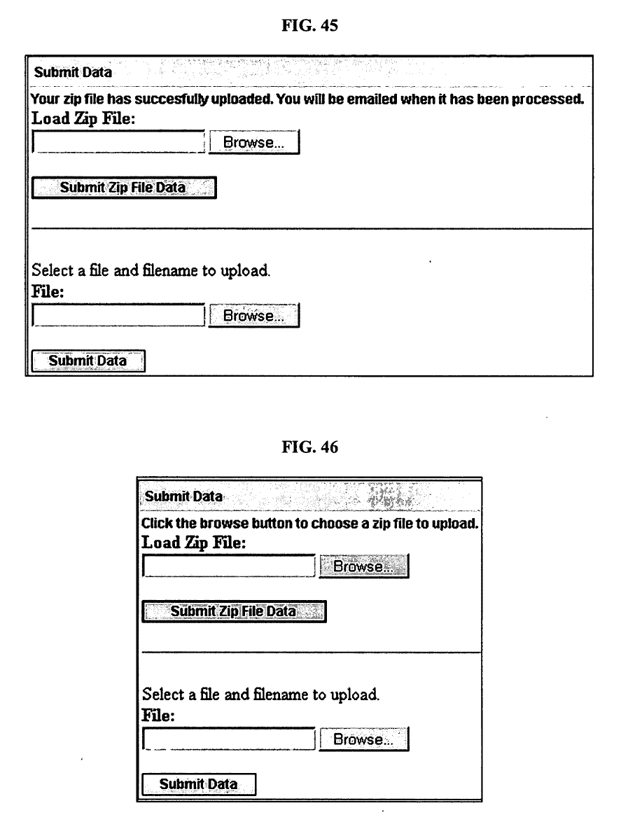

The user has to click on the ‘Browse’ button to load a zip file, and then click on the ‘Submit Zip File Data’ to upload the zip file into the selected file location (see FIG. 44). If the file gets uploaded, then a message is displayed as follows: “Your zip file has successfully uploaded. You'll be emailed when it has been processed.” (See FIG. 45).

If the user clicks on the ‘Submit Zip File Data’ button without selecting a file, then an error message is displayed as follows: “Click the browse button to choose a zip file to upload.” (See FIG. 46).

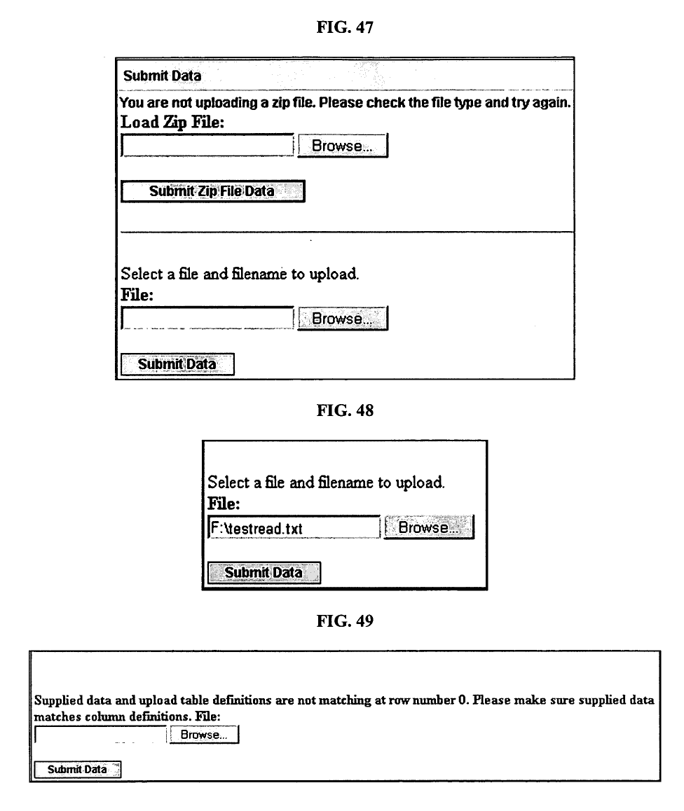

If the user selects a file other than a zip file, an error message is displayed as follows: “You are not uploading a zip file. Please check the file type and try it again.”)See FIG. 47).

Once the zip file is uploaded, an authorized user will be able to unzip the file and load it into the target table. The user is then emailed about the status of the uploaded zip file as to the number of rows that were updated and added. The zip file is then unzipped and the individual files are processed as if individually uploaded.

Uploading a Text File

A similar process is repeated for loading text files. The user has to first select a file by clicking on the ‘Browse’ button and then clicks on the ‘Submit Data’ button to upload the selected text file. See FIG. 48.

If the user uploads a text file that does not match the table definitions, then an error message (see FIG. 49) is displayed to the user.

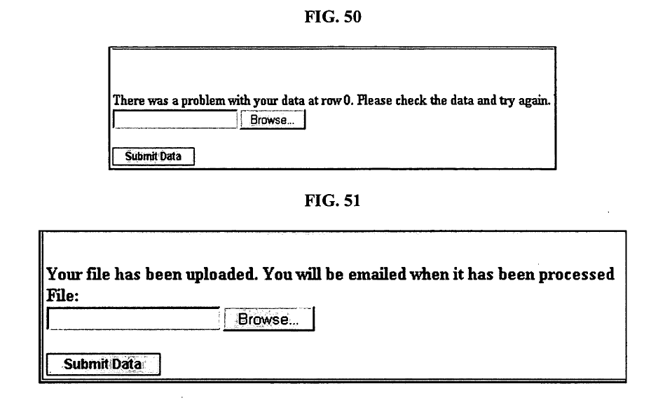

If the user uploads a text file that contains one or more values that don't match the data types of the target table then an error message (see FIG. 50) is displayed to the user. If the file is uploaded successfully, then the appropriate message (see FIG. 51) is displayed to the user.

Once the text file is uploaded, a thread is triggered on the server to load the file into the target table. The user is then emailed about the status of the uploaded text file as to the number of rows that were updated and added. Then the file status in the designated tracking file will be changed to ‘Success’.

Custom Reports-Report Builder

The Custom Reports module serves as the foundation for the development of customized data query applications. This module provides a platform that accommodates a data grid representing data that is tagged by variables and timeframes.

This module enables customers to quickly select variables, timeframes, and data elements from this data grid. Once selected, these elements can be arranged to the customer's tailored needs dynamically at run-time. As a result, the customer will receive an abundant amount of customized reporting information without the need for the software provider to spend a lot of time performing these repetitive tasks.

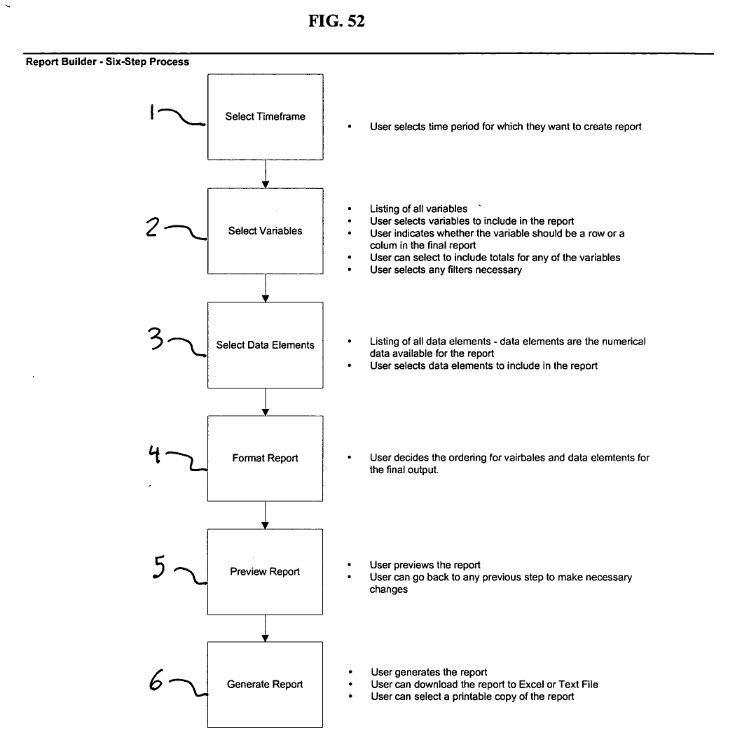

The custom reports are generated using the overall steps in FIG. 52, which are then defined in greater detail with reference to the screen shots accompanying the text below.

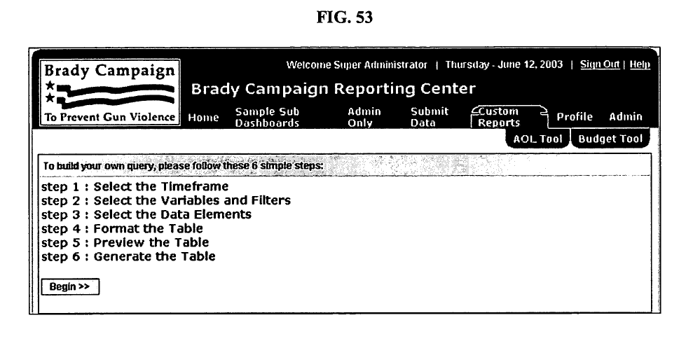

As shown in FIG. 53, the core functionality for the user is represented by the 6-step process flow diagram illustrated above, combined with the detailed description below:
1. Select the Timeframe
2. Select the Variables and Filters
3. Select the Data Elements
4. Format the Table
5. Preview the Table
6. Generate the Table

Step 1—Timeframes

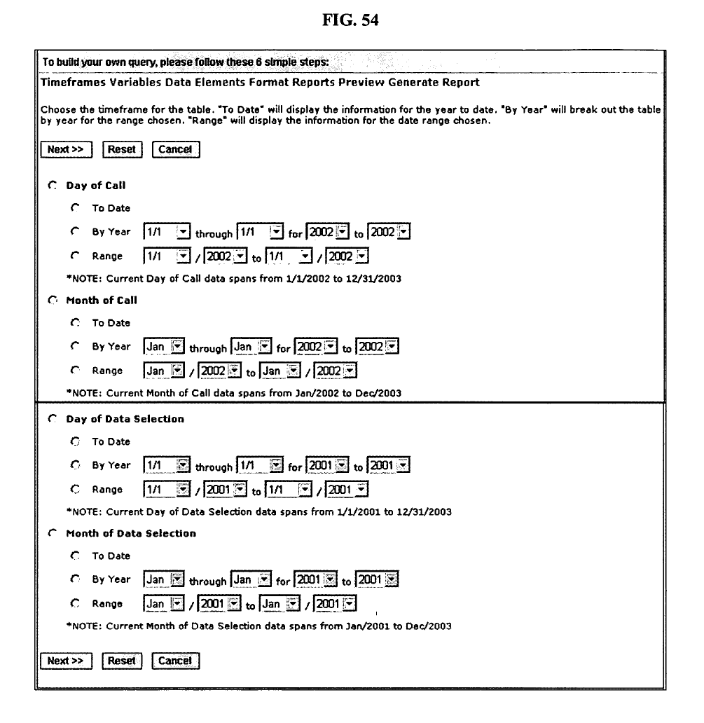

Timeframes are the spans of time for the data elements. Timeframes are always represented in the table as columns. The timeframe can be shown in at least three different ways: year or fiscal year to date, month ranges compared by year, and a single date range. There can be more than one timeframe associated with the data, i.e., fiscal year and calendar year. Typically the year is divided into monthly units, but it would be possible to create a timeframe of other kinds of units such as billing cycles or fiscal quarters. See FIG. 54.

Choose the timeframe for the table. “To Date” will display the information for the year to date. “By Year” will break out the table by year for the range chosen. “Range” will display the information for the date range chosen.

Clicking on the ‘Next’ button will go to step 2. The ‘Reset’ button will clear the selections and the ‘Cancel’ button will take the user back to the ‘Custom Reports’ tab.

Step 2—Variables

Select Variables

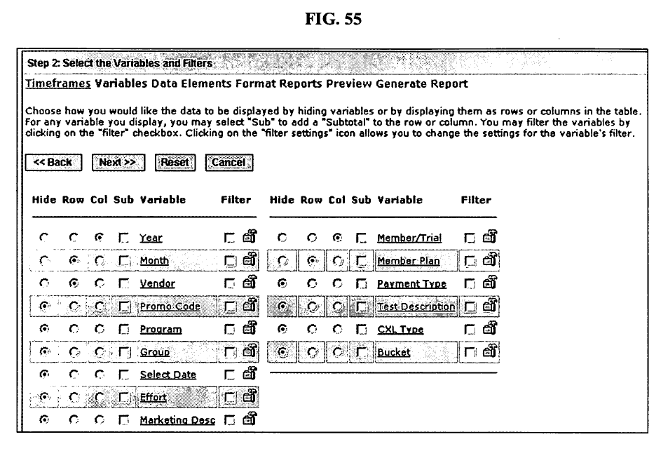

The user is presented with a list of the variables contained in the data grid. See FIG. 55. The user can designate each variable to be displayed as a row, displayed as a column, or not displayed. If a variable is part of a group, the user will be prevented from displaying more than one variable from that group. For instance if variables A, B, and C were grouped, you could display and filter either A or B or C but not two or three.

For any variable you display, you may select “Sub” to add a “Subtotal” to the row or column. You may filter the variables by clicking on the “filter” checkbox. Clicking on the “filter settings” icon allows you to change the settings for the variable's filter.

Select Filters

The user is presented with a list of the variables contained in the data grid. When the user selects a variable to be used as a filter, the user is presented with a list of all possible values for that variable. By selecting one or more values from the list, the query will be restricted to rows containing that value for the variable filtered.

Clicking on the ‘Next’ button will go to step 3. The ‘Reset’ button will clear the selections, the ‘Cancel’ button will take the user back to the ‘Custom Reports’ tab and the ‘Back’ button will take the user to previous page (step 1).

Step 3—Data Elements

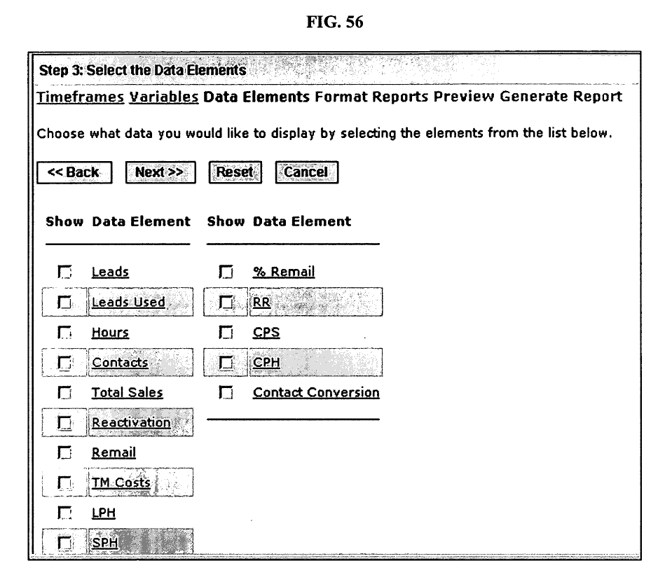

Each data grid will contain one or more data elements. Data elements are numerical data available for the report. Data elements are always displayed as columns. Data Elements cannot be filtered but they can be shown or hidden as the user needs. See FIG. 56. The user can choose what data to display by selecting the elements from the list above.

Clicking on the ‘Next’ button will go to step 4 (step04.aspx), the ‘Reset’ button will clear the selections, the ‘Cancel’ button will take the user back to the ‘Custom Reports’ tab and the ‘Back’ button will take the user to previous page (step2).

Step 4—Format Reports

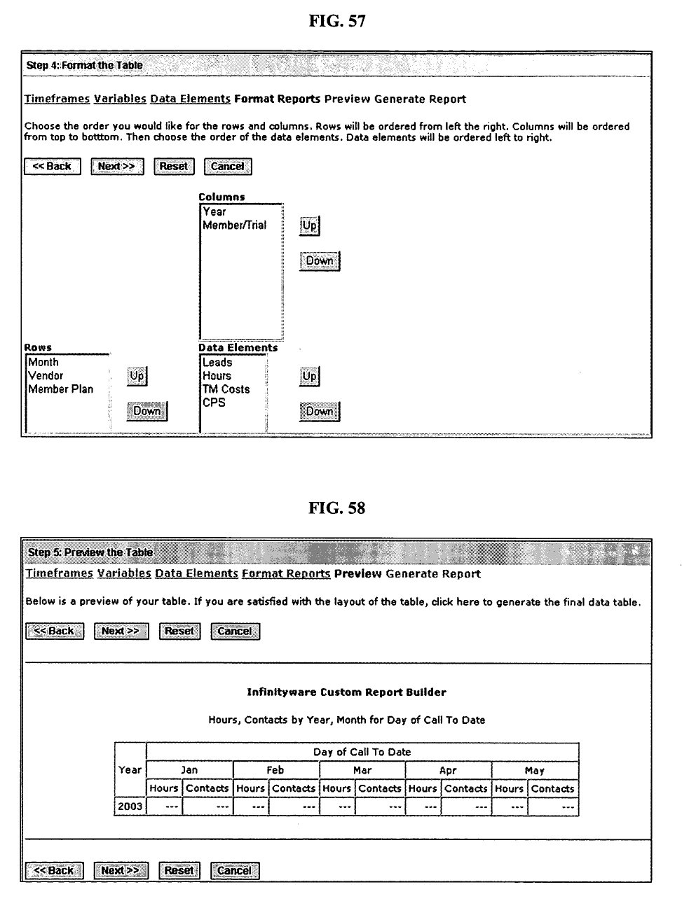

The user is presented with a list of the variables to be displayed as rows, and a list of the variables to be displayed as columns. The user is allowed to reorder this list to reflect the order in which the user wants the variables displayed within the table layout. See FIG. 57.

The user can click on ‘Up’ Or ‘Down’ buttons to move the rows, columns or data elements within the list. The user can choose the order for the rows and columns. Rows will be ordered from left the right. Columns will be ordered from top to bottom. Then the user can choose the order of the data elements. Data elements will be ordered left to right.

Clicking on the ‘Next’ button will go to step 5. The ‘Reset’ button will clear the selections, the ‘Cancel’ button will take the user back to the ‘Custom Reports’ tab and the ‘Back’ button will take the user to previous page (step3).

Step 5—Preview

The user is presented with a preview of the table being constructed. The table will be in the exact format as the final table without any data being inserted. The user can repeat steps 1-3 until satisfied with the preview. When satisfied, the user can choose to have the final table generated. See FIG. 58.

Clicking on the ‘Next’ button will go to step 6. The ‘Reset’ button will clear the selections, the ‘Cancel’ button will take the user back to the ‘Custom Reports’ tab and the ‘Back’ button will take the user to previous page (step4).

Step 6—Generate Report

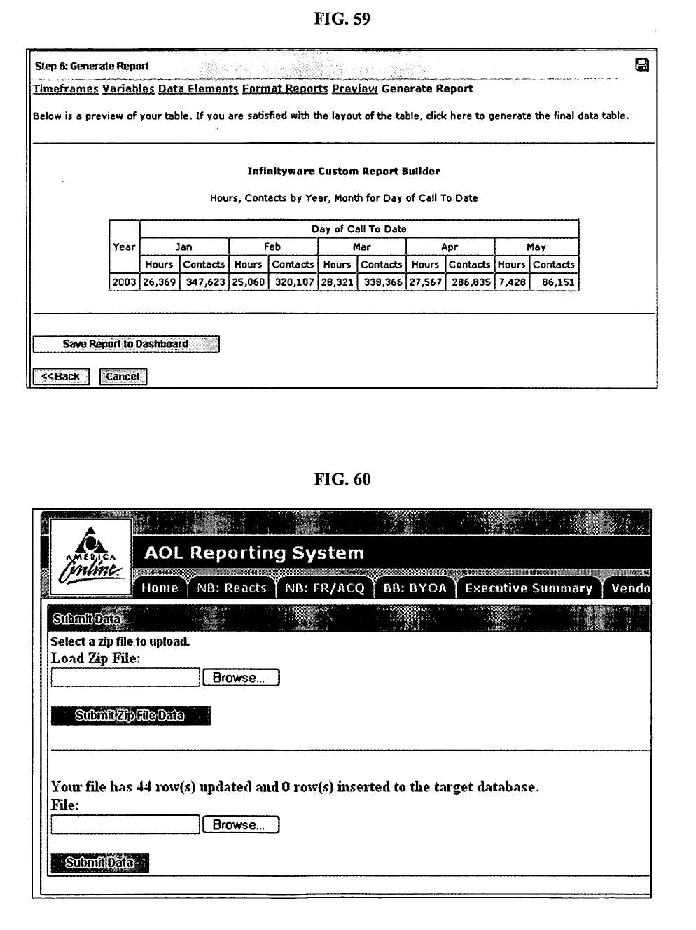

The final table will be generated by the server and displayed for the user. The data for these reports will be retrieved from database. See FIG. 59.

The user can click on ‘Save Report to Dashboard’ to save the report to the Dashboard and it appears on the main page. Clicking on the ‘Cancel’ button will take the user back to the ‘Custom Reports’ tab and the ‘Back’ button will take the user to previous page (step5). Additionally the user can click “Save Report to My Reports” to save the report to their personal report dashboard.

Excel Export

The user can click on the ‘Save’ icon at the top right hand side corner of the generated report to export this table to Excel.

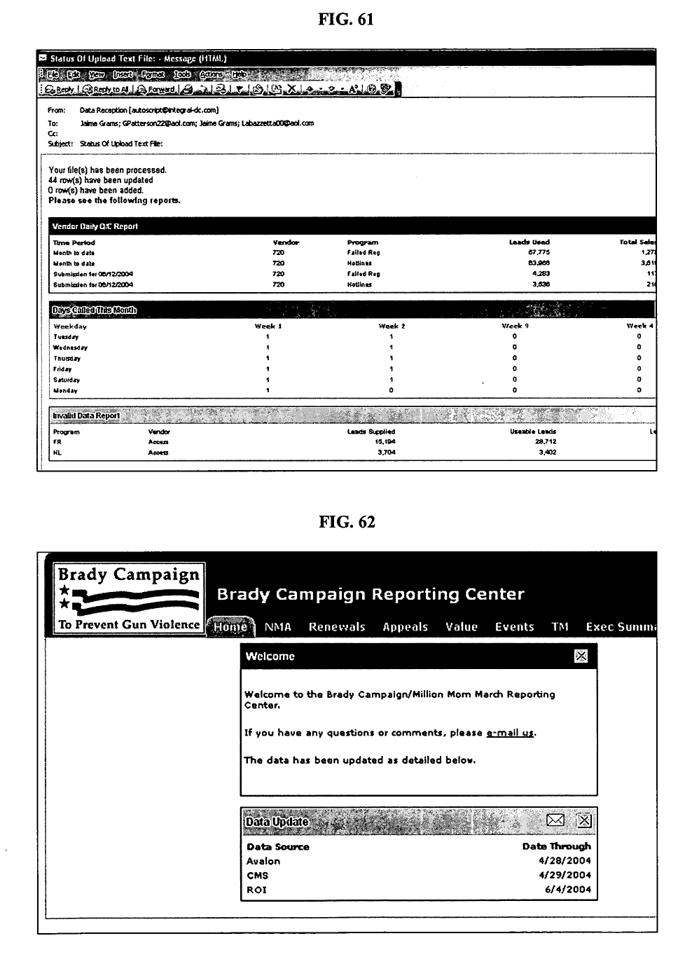

When new reports are updated, the system tracks the new data and automatically notifies report recipients of the update reports are available. FIG. 60 is an example of a confirmation that a data file was posted to the website successfully. FIG. 61 is an example of email correspondence summarizing data submitted that is sent to the person that posted the data file. Any additional contacts may be copied on the email. FIG. 62 is the Data Updated Through Module on the Home Page of the reporting site letting the user know what date the data has been received through.

The present invention thus provides a reporting system in which report content is posted in electronic format from predefined analytical criteria. An interface allows users to create customized reports and update reports in one-step without the skills of a professional programmer. The system allows for multiple users with different reporting needs with user control and report criteria defined by administrators. Report recipients are automatically notified when their reports are updated. The server presents clients with a user interface that can be branded for an organization. The server presents customized information based on the individual needs of the users, and the users need no software installation to create the custom reports.

While the present invention has been described in detail with reference to the preferred embodiments thereof, it should be understood to those skilled in the art that various changes, substitutions and alterations can be made hereto without departing from the scope of the invention as defined by the appended claims.

1. A process for generating and modifying customized reports based on criteria specified by a user, comprising:
uploading data supplied by the user to a database structure, the database structure having predefined data elements specified by the user;
selecting report data elements from the predefined data elements;
selecting timeframes for the report data elements;
selecting variables associated with the report data elements;
formatting a table layout including the selected variables; and
generating a report comprising the formatted table layout and displaying the report to the user, whereby the user can change the report by modifying any one of the prior selecting or formatting steps, without reprogramming a database program or application processing software associated with generating the report.

2. The process of claim 1, further comprising exporting the report to a third party spreadsheet application.

3. The process of claim 1, further comprising branding the report in accordance with the preferences of the user.

4. The process of claim 1, further comprising automatically updating the report at designated intervals.

5. The process of claim 4, further comprising automatically notifying report recipients when reports are updated.

6. The process of claim 1, wherein multiple users with different reporting criteria can access the predefined data elements to generate custom reports simultaneously.

7. The process of claim 6, wherein the reports are generated or distributed according to one of user-specified categories and permission levels.

8. The process of claim 1, further comprising previewing the table layout before generating the report.

9. The process of claim 8, further comprising modifying the table layout and then previewing the table layout again before generating the report.

10. The process of claim 1, wherein the selecting the variables step includes selecting a display format option for the variable.

11. The process of claim 10, wherein the display format options comprise a row, a column, and a not displayed option.

12. The process of claim 1, wherein the selecting the variables step includes selecting a variable to be used as a filter.

13. The process of claim 12, further comprising selecting a value for the variable used as the filter.

14. The process of claim 1, wherein the formatting the table layout step further comprises a step of reformatting the selected variables in a different table layout.

15. The process of claim 1, further comprising modifying the database structure by adding data elements, deleting data elements or modifying the predefined data elements.

16. A graphical user interface for generating and modifying customized reports based on criteria specified by a user, comprising:
means for uploading data supplied by the user to a database structure, the database structure having predefined data elements specified by the user;
means for selecting report data elements from the predefined data elements;
means for selecting timeframes for the report data elements;
means for selecting variables associated with the report data elements;
means for formatting a table layout including the selected variables; and
means for generating a report comprising the formatted table layout and displaying the report to the user, whereby the user can change the report by modifying any one of the prior selecting or formatting steps, without reprogramming a database program or application processing software associated with generating the report.

17. The process of claim 16, further comprising a means for automatically updating the report at designated intervals.

18. The process of claim 17, further comprising a means for automatically notifying report recipients when reports are updated.

19. The process of claim 16, wherein the means for formatting the table layout comprises a means for reformatting the selected variables in a different table layout.

20. The process of claim 16, further comprising a means for modifying the database structure by adding data elements, deleting data elements or modifying the predefined data elements.
